(19) United States
(12) Patent Application Publication
(10) Pub. No.: US 2004/0122733 A1
(43) Pub. Date: Jun. 24, 2004

(54) Methods of associating a targeted advertisement with customers, methods of recording information, methods of making labels, and labels

(75) Inventors: Thomas P. Hanschen, St. Paul, MN (US); Guglielmo M. Izzi, Maplewood, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/328,669

(22) Filed: Dec. 24, 2002

(51) Int. Cl. G06F 17/60

(52) U.S. Cl. 705/14

(57) ABSTRACT

Methods of associating a targeted advertisement with a customer who ordered a product or service, methods of recording information on at least two items, and methods of making a label for packaging for an ordered product or service. The present invention also generally relates to labels including targeted advertisements, labels for packaging for an ordered product, label assemblies and methods of printing a label assembly.

### TECHNICAL FIELD

The present invention relates to methods of associating a targeted advertisement with a customer who ordered a product or service, methods of recording information on at least two items, and methods of making a label for packaging for an ordered product or service. The present invention also generally relates to labels including targeted advertisements, labels for packaging for an ordered product, label assemblies and methods of printing a label assembly.

### BACKGROUND OF THE INVENTION

There are many known ways in which to advertise a product to a customer. One example is disclosed in published U.S. Patent Application 2002/0026359 A1, “Targeted Advertising Method and System,” (Long et al.). This publication discloses a method of targeted advertising includes generating a targeted advertising and/or promotional campaign material corresponding to a client's selections, fulfilling the targeted advertising and/or promotional campaign material, and providing a response tracking analysis to the client. There are also many known ways in which to gather information about customers. For example, U.S. Pat. No. 6,039,244, “Method of Building up a Data Bank Containing Customer Data and/or for the Organization of Rebate or Coupon System,” (Finsterwald). This patent discloses a method of building up a data bank containing customer data and/or for the organization of a rebate or coupon system.

There are also many known methods and systems for printing labels and applying labels and uses of the labels. One example is disclosed in U.S. Pat. No. 6,304,849, “Method and System for Printing a Combination Pharmaceutical Label and Directed Newsletter,” (Uecker et al.). This patent discloses a system and method for printing a customized combination newsletter and product label for used in dispensing prescribed pharmaceutical products. Another example is U.S. Pat. No. 5,704,650, “Laminated Label Form with Removable Portions,” (Laurach et al.). This patent discloses a multiple-ply label form which includes a plurality of readily removable elements for use in facilitating business operations, such as package shipment.

Systems for printing and applying tape are also known. For example, a system of printing and applying tape is disclosed in U.S. Pat. No. 6,432,528 “Variably Printed Tape and System for Printing and Applying Tape onto Surfaces” (Faust et al.) This patent discloses an apparatus for printing variable information on a tape to form a tape segment, for cutting the tape segment to form a tag, and then applying the tag onto an object.

### SUMMARY OF THE INVENTION

One aspect of the present invention provides a method of associating a targeted advertisement with a customer who ordered a product or service. This method comprises the steps of: receiving an order from a customer for a product or service; selecting an targeted advertisement based at least in part on one of the following: information associated with the customer or information associated with product or service ordered; printing a label with the targeted advertisement; applying the label to a package for the product or service; and delivering the product to the customer with the targeted advertisement;

Another aspect of the present invention provides a label including a targeted advertisement. The label comprises: a substrate including a first side and a second side opposite the first side; a layer of adhesive on the second side of the substrate; an advertisement printed on the first side of the substrate, wherein the advertisement is selected in response to one of the following: information associated with the customer and information associated with product or service ordered.

Yet another aspect of the present invention provides a method of making a label for packaging for an ordered product. This method comprises the steps of: receiving an order from a customer for a product; printing a label with a graphical representation of the ordered product; and applying the label to a package for the product.

Another aspect of the present invention provides a label for an ordered product. This label comprises: a substrate including a first side and a second side opposite the first side; a layer of adhesive on the second side of the substrate; a graphical representation of the ordered product printed on the first side of the substrate graphical representation of the ordered product.

Yet another aspect of the present invention provides a label assembly. This label assembly comprises: a first label including a first major surface, a second major surface opposite the first major surface, and a layer of adhesive on the second major surface; and a second label including a first major surface, a second major surface opposite the first major surface, and a layer of adhesive on the second major surface, wherein said first major surface of said first label is adhered to the second major surface of the second label by the adhesive on the second major surface of the second label; wherein said first major surface of said first label has a first label area and said first major surface of second label has a second label area, and wherein said first label area is greater than said second label area.

Another aspect of the present invention provides a method of printing a label assembly. This method comprises the steps of: providing a label assembly, comprising: a first label including a first major surface, a second major surface opposite the first major surface, and a layer of adhesive on the second major surface; and a second label including a first major surface, a second major surface opposite the first major surface, and a layer of adhesive on the second major surface, wherein said first major surface of said first label is adhered to the second major surface of the second label by the adhesive on the second, major surface of the second label; wherein said first major surface of said first label has a O-first label area and said first major surface of second label has a second label area, and wherein said first label area is greater than said second label area; and printing information on the label assembly.

### BRIEF DESCRIPTION OF THE DRAWINGS

The present invention will be further explained with reference to the appended Figures, wherein like structure is referred to by like numerals throughout the several views, and wherein:

FIG. 1 is a flow diagram of method of associating a targeted advertisement with a customer who ordered a product or service according to an embodiment of the present invention;

FIG. 2 is a flow diagram of a method of associating a targeted advertisement with a customer who ordered a product or service according to another embodiment of the present invention;

FIG. 3 is a flow diagram of a method of making a label for packaging for a product or service ordered by a customer according to an embodiment of the present invention;

FIG. 4 is a flow diagram of portions of the method steps illustrated in FIG. 2 and FIG. 3 combined together according to another an embodiment of the present invention;

FIG. 5 is a top view of a label according to an embodiment of the present invention;

FIG. 6 is a top view of a label according to another embodiment of the present invention;

FIG. 7 is a side view of the label of FIG. 5; and

FIG. 8 is a side view of the label of FIG. 6.

### DETAILED DESCRIPTION OF THE INVENTION

With the growth of the Internet and mail order catalogues, ordering products or services online via computer or over the phone has become very common. Typically, a customer will place an order for a product or service on a company's web site or over the phone or by facsimile by submitting information about themselves, such as their name, mailing address, and credit card number, and then submitting the catalogue or part numbers affiliated with the product or services they want to order. This information about the customer and about the product and services they ordered is typically entered into or transferred to one of the company's computer databases, where the information is stored. The company offering the product or services will then fulfill the order based on the information stored on the database, and either mail the products directly to customer, or provide the services at some later date requested by the customer.

Typically, if the customer ordered a product, the product will be delivered to the designated mailing address in a package, such as an envelope or box. If the customer ordered a particular service, the receipt for services ordered or a brochure about the company's services may be mailed to the designated mailing address in a package, such as an envelope. The packages often arrive with labels adhered to the outside of the packages. Often these labels are preprinted, and then adhered to the package prior to mailing. The preprinted labels may convey a variety of information, such as mailing addresses, lot numbers, date codes, product identification information, bar codes, manufacturing information, source information, regulatory information, customer and transportion information, expiration date or delivery date. These labels often include adhesives, such as pressure sensitive adhesives, for adhering the labels to packages. Companies keep much inventory of the different preprinted labels, which are usually on a liner and stored in a roll. Often, these labels may become obsolete for a variety of reasons, such as changes to products, and may need to be destroyed, and new replacement labels may need to be generated.

Also, it is typical of companies to enclose a brochure or catalogue about their products or services in the package mailed to the customer. The brochure or catalogues are generated ahead of time, and each customer receives the same brochure or catalogue, regardless of what product or service they had previously ordered.

There is a need to reduce the inventory of preprinted labels described above. There is also a recent trend in conveying information related to the product or customer specific for package containing the product or receipt for the service. For example, each package, could carry specific information about its contents and the final destination of the product, including lot numbers, serial numbers, and customer order numbers. The information is typically provided on labels that are customized and printed on demand at the point of application onto the box. This is typically known as the ability to print “variable” information onto a label before it is applied onto the package, such as a box. There is also an opportunity to use the information collected from the customer at the time when they order the product or service to develop better advertising which is more targeted to the customer or affiliated with the products or services they ordered. There is also an opportunity to convert the labeling aspect of products or services from a cost to a source of new revenue stream or future profits.

There is an opportunity to use the label assemblies described in this application to accurately and easily record information on at least two items.

The present invention provides a variety of methods of associating a targeted advertisement with a customer who ordered a product or service, methods of recording information on at least two items, and methods of making a label for packaging for an ordered product or service. The present invention also provides labels including targeted advertisements, labels for packaging for an ordered product, label assemblies, and methods of printing a label assembly.

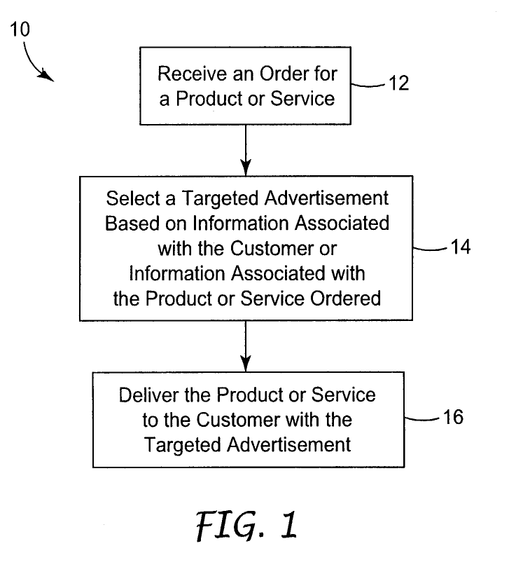

FIG. 1 illustrates a method 10 of associating a targeted advertisement with a customer who ordered a product or service. This method 10 includes a first step 12 of receiving an order for a product or service. An order could be a request for more information or a purchase order for a product or service. The sales agent of the company receiving the order from the customer usually performs this step. The customer may place his or her order for the product or service through his or her computer online over the Internet or may place the order over the phone. Examples of products that could be ordered in step 12 include: clothing, books, shoes, CDs or DVDs, spare mechanical parts, medical supplies, office supplies, home improvement supplies, or consumer items. However, any product may be ordered by a customer in step 12 of method 10. Examples of services that could be ordered in step 12 include: vacation planning services, renting or selling movies, CDs or DVDs, services affiliated with buying, selling or advertising real estate, legal services, purchasing service manuals or instructions, news or magazine services, services for obtaining government-issued documents, such as passports, or house or machine repair services. However, any service may be ordered by a customer in step 12 of method 10.

After the order is received in step 12, step 14 happens in response. The second step 14 of the method 10 includes selecting a targeted advertisement based on information a associated with the customer or receiver of the order or information associated with the product or service ordered by the customer in step 12. This information associated with the customer, product or services may be entered into a computer database or program. The company receiving the order may then use the information gathered from the customer in step 12, specifically information about or associated with the customer or information about or associated with the product or service, to select an advertisement, which is specifically targeted at the customer who placed the order in step 12. Examples of information associated with the customer include the following: the customer's name, the customer's gender and marital status, the customer's age, the customer's mailing location, the customer's likes or dislikes, the customer's previous purchases from the company, the customer's catalogue number, the customer's hobbies, the customer's native language or the language most commonly spoken in the country where the customer lives for delivery purposes. However, any information gathered about the customer at the time of purchase maybe used to directly or indirectly select an advertisement appropriately targeted at the customer. For example, once the customer's mailing address is determined, the customer's general geographical location may be determined, for instance, within 100 miles of the customer's mailing address, then a targeted advertisement for a store located within the customer's geographical location may be selected. Preferably, the customer's geographical location is within 50 miles of the customer's mailing address, and more preferably, within 25 miles of the mailing address. Examples of information associated with the product(s) ordered by the customer include the following: the product's use, the brand of the product, if the product is a seasonal product, such as a product affiliated with Christmas or Hanukkah, or other products that are affiliated with the general category of the product ordered. Examples of information associated with the service(s) ordered by the customer include the following: what the service is associated with, where the service is performed, how long the service will take to complete, if the service is seasonal. However, any information about the product or service maybe used to directly or indirectly select an advertisement appropriately targeted at the customer.

For example, if the product ordered by the customer is an electric toothbrush, then X a targeted advertisement for a local dentist or orthodontist who offer services within the customer's geographical location or an advertisement for teeth whitening products may be selected. As another example, if the service ordered by the customer is a request to compare several different mortgage rates at several banks, then a targeted advertisement for financial services within the customer's geographical location or a special offer for a year's subscription to Money Magazine may be selected. As another example, if a customer orders a new glucose monitor to monitor their diabetes, then a targeted advertisement for cookbooks on how to control diabetes or health food delivery services may be selected.

The term “targeted advertisement” used herein, including the claims, is defined as an advertisement that is directed specifically at the customer who ordered and receives the product and/or services. The targeted advertisement is one that contains something related to the customer as an individual, or related to the customer's specific order for the product or services. Alternatively, if the product or service is to be delivered to someone else, as a gift for instance, the targeted advertisement could be targeted at the person who is receiving the product or service. In contrast, a non-targeted advertisement is an advertisement that is mass-produced and directed to any customer regardless of the customer's individual characteristics or the characteristics of the product or services they have previously ordered. A variety of targeted advertisements may be stored on a database or program on a computer ahead of time. It is also possible that the advertising companies may pay to have their advertisements stored on the database for selection later in method 10.

Examples of a suitable computer databases or programs for collecting information about the customer, products selected, and services selected, and for storing, selecting, and printing the targeted advertisements are taught in U.S. patent application Ser. No. 10/16,7968, “Centralized Management Of Packaging Data With Rule-Based Content Validation,” (Zimmerman et. al) which was filed on Jun. 10, 2002, and U.S. patent application Ser. No. 09/893,823, “Package Labeling,” (Vandenavond et. al), filed on Jun. 28, 2002, both of which are owned by the same assignee as the present application. However, other relational databases known in the art may be used.

After the targeted advertisement is selected in step 14, then the product or service is delivered to the customer with the targeted advertisement in step 16 of the method 10. The targeted advertisement maybe delivered with the product or service in a variety of ways. For example, the targeted advertisement maybe included in the package for the product. For example, the targeted advertisement could be attached to the interior or exterior of a box or placed inside a box, where the box contains the product therein. Alternatively, the targeted advertisement could be attached to or part of the receipt for the product or service.

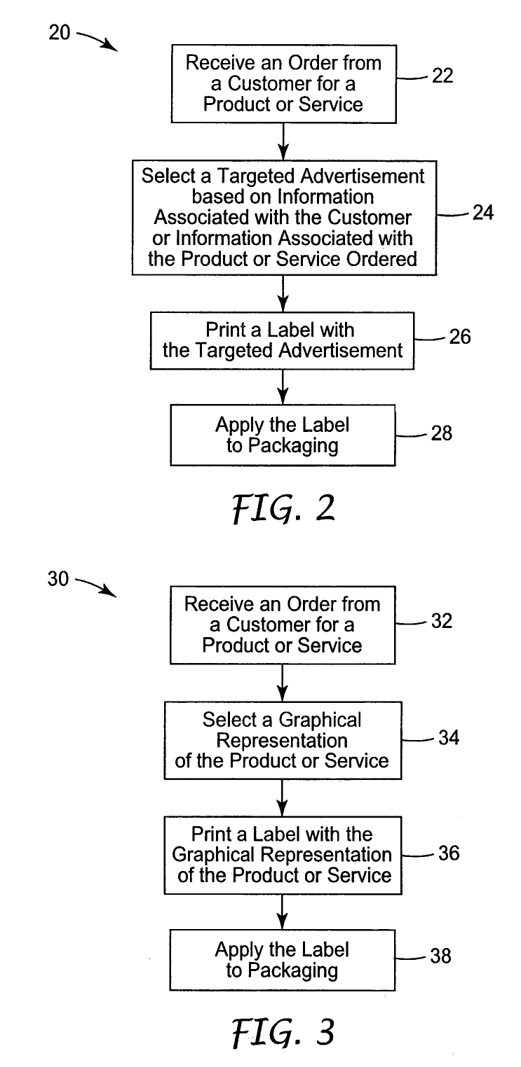

FIG. 2 illustrates an alternative method 20 of associating a targeted advertisement with a customer who ordered a product or service. This method 20 includes the step of printing a label with the targeted advertisement and applying the label to packaging for the product or service. Packaging may be any wrapping, covering, or casing for the product or for housing a receipt for the services, such as an envelope or box. Method 20 includes a first step 22, which includes receiving an order from a customer for a product or service. This method step 22 is the same as method step 12 described above in reference to method 10. Method 20 includes a second step 24, which includes selecting a targeted advertisement based on the information associated with the customer or information associated with the product or service ordered in step 22. This method step 24 is the same as the method step 14 described above in reference to method 10. In step 24, the targeted advertisement is generated in response to the receiving step 22.

Step 26 of method 20 includes printing a label with a targeted advertisement. Preferably, the label is printed just prior to applying the label the package. Preferably, the label has variable printing on it. Throughout this description, the term “variable” printing means printing customized information on demand to form a label (such as at the point of application of the label). Information is any information including words, symbols, graphics or barcodes. The labels may include nonvariable printing, that is the same information preprinted on the labels, such as the company's logo.

A “label” as the term is used herein, including the claims, is any substrate, for example paper, film, laminates of paper and films, multilayer films or foils, with a layer of adhesive attached to the substrate, which may be printed with information for the purpose of conveying information to the reader. Labels may be die-cut labels stored on a liner.

Alternatively, labels may a portion of a tape that is severed from the remainder of the strand or roll of tape to become a label. The tape and labels may be linerless or with a liner. An example of a suitable tape is commercially available under 3M brand as Paper Label Material, No. 7109 and under 3M brand as Label Material, No. 7350FL, from 3M Company, located in St. Paul, Minn. Examples of labels on a liner sheet are Laser Labels commercially available from Simon Labels Ltd. located in Rochester N.Y. under part number 11440, or labels from Desk Top Labels located in Minneapolis, Minn. under part number 7710A.

A printer may be used to print the label. The printer may print in an monochromatic ink, that is pertaining to one color, such as black ink, or may print in polychromatic inks, that is pertaining to more than one color, such as cyan, magenta, and yellow, and black. Preferably, the printer is an inkjet printer including a print head. A computer can control the ink pattern sprayed onto the label. Alternatively, the printer may be a thermal transfer printer or electrophotographic printer. Examples of a suitable printers include a printers commercially available under model number M8485Se from Sato America Inc. located in Sunnyvale, Calif. or a thermal transfer printer under model number PE-42 from Datamax Inc. located in Orlando, Fla. or a thermal transfer printer under model DPM from NOVEXX OEM Printers and Labellers located in Philadelphia, Pa. An example of a polychromatic printer is commercially available under model number P640L from Canon Aptex, located in Tokyo, Japan.

Step 28 of method 20 includes applying the label to the packaging for the product or service ordered. The packaging referred to in step 28 maybe any packaging that includes a product therein. For example, the packaging may be a box or an envelope. Alternatively, the packaging for a service could include a receipt for the service ordered inside an envelope. Print and apply apparatuses i-may be used to perform step 26 and 28 in method 20. Examples of apparatuses that print and apply labels or portions of tape cut from a roll of tape include those apparatuses taught in U.S. Patent Application “An Apparatus for Printing and Applying Tape and Labels and Methods of Printing and Applying Tape and Labels,” filed on Dec. 11, 2002, Ser. No. 10/316,351, Attorney Docket No. 58216US002, “which is co-owned by the same assignees as the present; application. Print and apply case sealing applicators and print and apply corner sealing applicators are also commercially available from 3M Company located in St. Paul, Minn. under the brand name 3M-Matic as CA2000 Corner Label Applicator and PS2000 Print & Seal Applicator.

FIG. 3 illustrates a method 30 of making a label for packaging for an ordered product. Method 30 includes a first step 32, which includes receiving an order from a customer for a product or service. This method step 32 is the same as method step 12 described above in reference to method 10. Method 30 includes a step 34, which includes selecting a graphical representation of the product or service. The term, “graphical representation” as used herein, including the claims, means any image, photograph, drawing. The method 30 includes step 36 of printing a label with the graphical representation of the product or service. The method also includes a step 38 of applying the label to the packaging. The information described above in regard to steps 26 and 28 in method 20 apply to the steps 36 and 38 of the method 30, except that a graphical representation is printed on the label instead of the targeted advertisement.

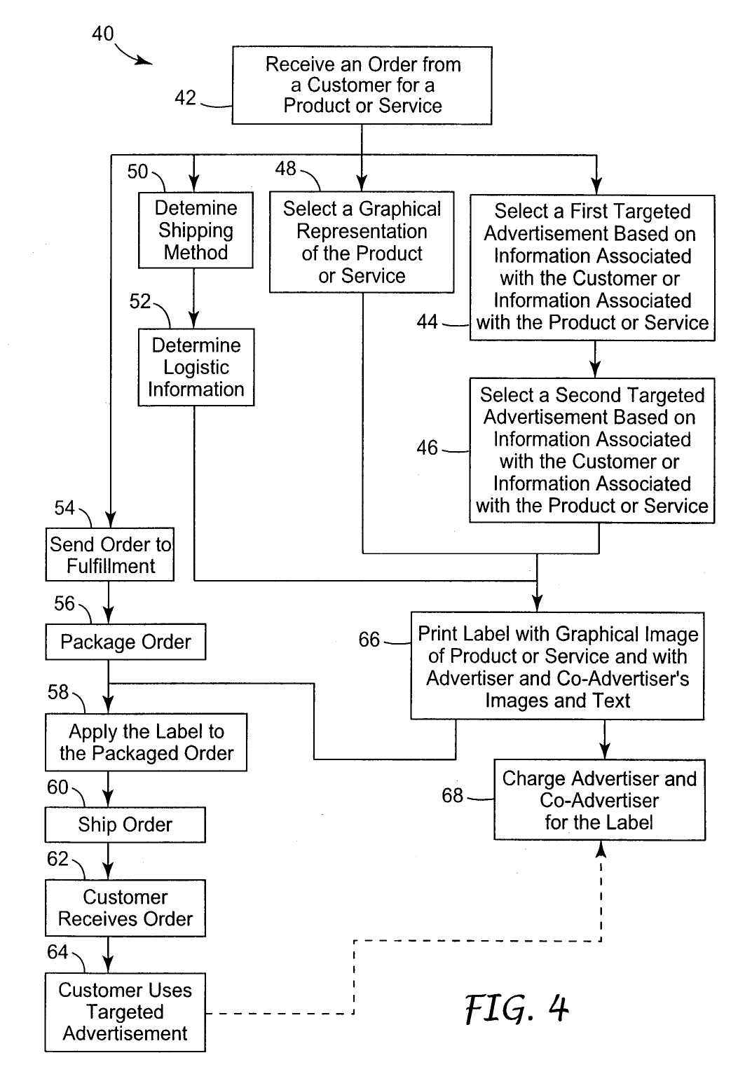

FIG. 4 illustrates another method of associating a target advertisement and a graphical representation of the product or service ordered by the customer. This method 40 combines some of the steps of method 20 and method 30. The method 40 includes step 42, which includes receiving an order from a customer for a product or service. This step 42 is the same as the step 22 of method 20. Once the order has been received, then optional step 50 is performed, which involves determining the shipping method for the product or service ordered in step 42. After the shipping method has been determined in step 50, the logistics information 52 may than be determined. Examples of logistic information include tracking information, destination of the final product or which company is used to deliver the product.

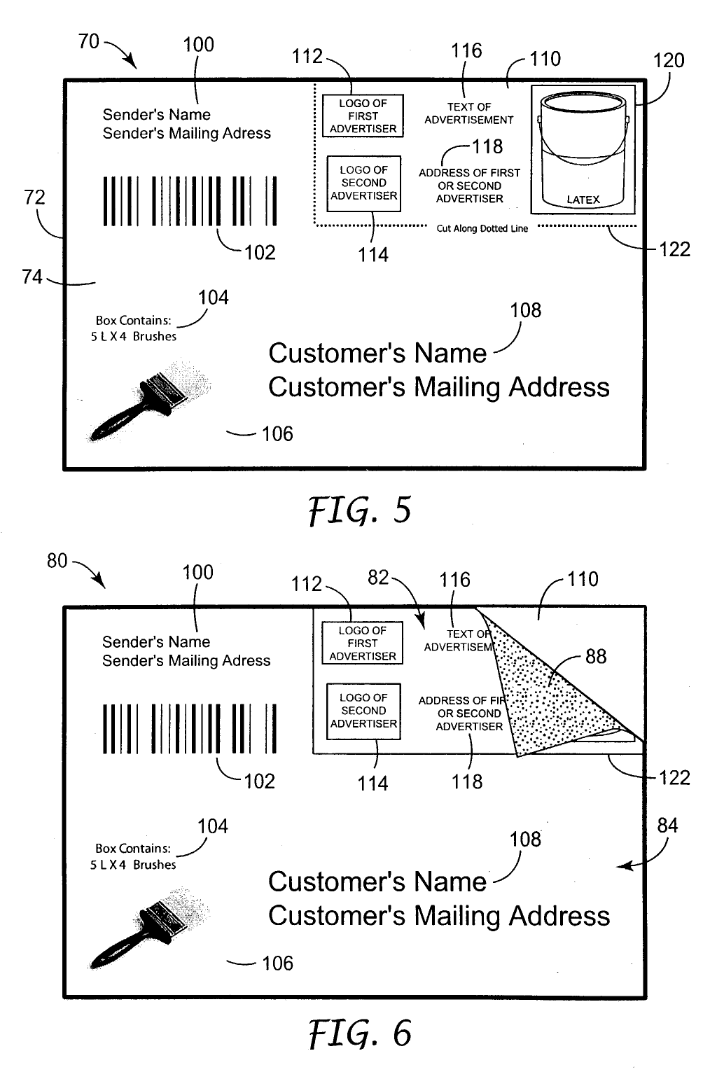

In addition, after the order has been received in step 42, then step 48 is performed, which includes selecting or identifying a graphical representation that represent the product or service. This step 48 is the same as step 34 of method 30. A graphical representation may include a photograph, drawing, or image which represents the product or service. For example, FIG. 5 illustrates a graphical representation of a paintbrush in section 106 and a graphical representation of a paint can in section 120. After the customer's order has been received in step 42, then the advertisers may be identified in step 44. The advertisers are identified based on information associated with the customer for the customer's order for the product or service that was gathered in step 42. This step 44 is the same as the step 24 in method 20. The method 40 may optionally include step 46. Step 46 includes selecting a second targeted advertisement based on information associated with the customer for the customer's order for the product or service that was gathered in step 42. An example of an advertiser in step 44 maybe a local Home Depot store. An example of a second advertiser or co-advertiser would be Glidden Co. for paint. In this example, Glidden brand paint is a product, which may be purchased at a Home Depot store.

After a customer's order has been received in step 42 for the product or service, the order may than be sent to a fulfillment area in a company that would provide the product or service ordered in step 42. After the order has been sent to fulfillment, the order may be packaged. For example, if a customer ordered a product, than the product may be inserted inside a package such as a box or envelope. If the customer has ordered a service, the receipt or a brochure about the service may be included in a package, such as an envelope.

Method 40 includes a step 66, where a label is printed with the graphical representation of the product or service and with the targeted advertisement based on the information gathered about the customer who placed the order or about the product or service ordered by the customer in step 42. Step 66 is the same as step 26 in method 20 combined with step 36 of method 30. The label may include a graphical representation for text affiliated with an advertiser or a co-advertiser identified in step 44 and step 46. An example of such a label in step 66 is illustrated in FIGS. 5 and 6 discussed below.

After the label has been printed in step 66, it may than be applied to the packaged order in step 58 of method 40. Step 58 is the same as step 28 in method 20 and step 38 in method 30. Next, the order is shipped to the customer in step 60. The customer receives the order in step 62. In step 64 of the method 40, the customer may use the targeted advertisement, which was on the label printed in step 66. Method 40 may include an optional step 68 where the advertiser and/or co-advertiser may be charged for the service of including their information on the label generated in step 66. Alternatively, the advertiser and co-advertiser may be notified that a label including their information was generated (in step 66) and sent to the customer (in step 60).

FIG. 5 illustrates one embodiment of a label 70. This label 70 may be applied anywhere to the packaging for the product or service. In one this embodiment, the label 70 is a mailing label including the customer's name and mailing address 108 and the sender's name and mailing address 100. However, it is not necessary that the label include either the sender's name and mailing address or the customer's name or mailing address. The label 70 may optionally include a barcode 102 which may be useful in tracking the transport or delivery of the product or service. The label 70 may include a graphical representation 106 of the product or service ordered by the customer. For example, if the customer ordered five paintbrushes, then the graphical representation may include a digital photograph of one of the brushes that is included in the package. Information 104 may list what the package contains. For example, the package would contain five LX4 brushes.

The label 70 may include a targeted advertisement 110. The targeted advertisement is generated as discussed in method 30 or method 40 described above. The targeted advertisement may include a logo of the first advertiser 112 or main advertiser. Alternatively, the targeted advertisement 110 may include the logo of a second advertiser 114 or a co-advertiser. The target advertisement 110 would include text 116 of the advertisement and the address 118 of either the first or second advertiser. Lastly, the targeted advertisement 110 may include a graphical representation 120 of the item, which is being advertised.

FIG. 6 illustrates a label assembly 80. The label assembly 80 is just like the label 70 described above, except that label assembly is made from a first label 84 and a second label 82, where the second label 82 is adhered to the first label 84 by the layer of adhesive 88 on the second label 82. Preferably, the first label 84 includes a first printable area, which is the area not covered by the second label 82. The second label 82 includes a second printable area. Preferably, the first printable area and second printable area are printed at substantially the same time by a single pass through a printer. Also, it is preferred that the first printable area is greater or larger than the second printable area. More preferably, the first printable area is at least two times larger than the second printable area. Most preferably, the first printable area is at least three times larger than the second printable area.

After a customer receives the targeted advertisement describe above in reference to step 62 in method 40, the advertiser may either cut the targeted advertisement out of the rest of the label 70 (illustrated in FIG. 5) or remove the second label from the label assembly 80 (illustrated in FIG. 6).

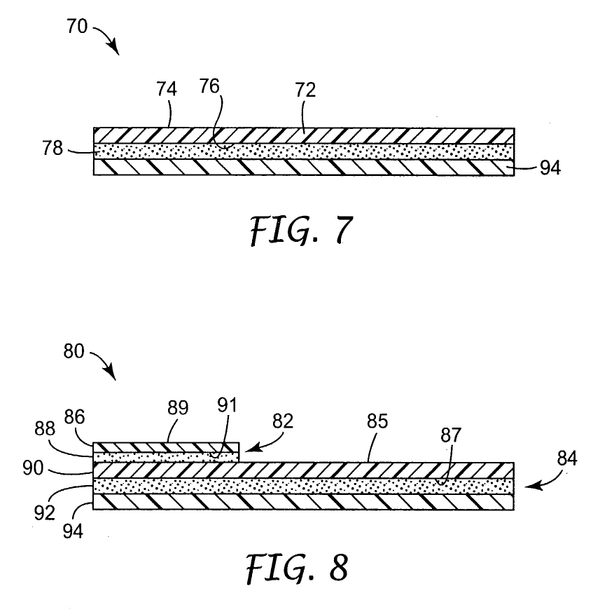

FIG. 7 illustrates a side view of label 70. Label 70 includes a first layer 72 including a first major surface 74 and a second major surface 76 opposite the first major surface 74. The label 70 includes a layer of adhesives 78 on the second major surface 76 of layer 72. The label 70 optionally may include a liner 94.

FIG. 8 illustrates a side view of label assembly 80 illustrated in FIG. 6. Label assembly 80 includes a first label 84 having a first major surface 85 and a second major surface 87 opposite the first major surface 85. A layer of adhesive 92 is on the second major surface 87 of label 84. The label assembly 80 includes a second label 82, which includes a first major surface 89 and a second major surface 91 opposite the first major surface 89. The label 80 includes a layer of adhesive 88 on the second major surface 91 of the second label 82. The label assembly 80 may include an optional liner 94 covering the adhesive layer 92. The layer of adhesive 88 attaches the first label 82 to the second label 84.

Method 40 and label 70 or label 80 could be used in the follow scenario. (Mrs. Evans, a customer, located in Cheboygan, MI orders from Painter's Warehouse, a company located in Dallas, Tex., over the phone. Mrs. Evans orders five paint brushes from Painter's Warehouse. When this order is placed, a user may enter information about Mrs. Evans and enter the information about the paintbrushes that she has ordered into a database. The database may then select a targeted advertisement for Glidden brand latex paint, which is being offered at $1.00/gallon discount when purchased at a Home Depot located in Gaylord, MI, which is geographically located closely to where Mrs. Evans's mailing address is in Cheboygan, MI. The targeted advertisement is printed on label, as described above, and applied to a package containing the brushes Mrs. Evans order. Mrs. Evans then receives the order for the brushes with the label 70, 80 attached to the box that the brushes came in. Then, Mrs. Evans may remove the second label 82 or cut along the dotted line 112 to remove the targeted advertisement 110 from the remaining portion of the label 70. She may than take the targeted advertisement 110 to Home Depot located in Gaylord, MI to redeem her coupon on Glidden brand paint. The targeted advertisement for paint was picked primarily because Mrs. Evans had ordered paintbrushes and because Mrs. Evans's mailing address is located close to a Home Depot that was having a sale on the Glidden paint.

The method 40 and label 70 or label 80 could be used in the follow scenario. Mr. Hanschen, a customer located in St. Paul, Minn., orders a new fishing lure from a web site called fishing.com. When this order is placed, a person may enter information about Mr. Hanschen and enter the information about the fishing lure that he has ordered into a database. The database may then select a targeted advertisement for vacation planning services, particularly those vacation planning services located in northern Minnesota. Alternatively, the database may select a targeted advertisement for a local fishing guide located in Lake of the Woods, MN which is geographically located closely to where Mr. Hanschen's mailing address in St. Paul, Minn. The label including both of targeted advertisement is printed out and applied to a box containing the fishing lure ordered by Mr. Hanschen. Mr. Hanschen then receives the order for the fishing lure with the label 70, 80 attached to the box that the fishing lure came in. Then, Mr. Hanschen may remove the second label 82 or cut along the dotted line 112 to remove the targeted advertisement 110 from the remaining portion of the label 70, 80. He may then use the information on the targeted advertisement to contact the vacation planning service to plan his next fishing trip in northern Minnesota or to arrange a guided fishing tour with the local fishing guide. The targeted advertisement for the vacation planning services and the local fishing guide was picked primarily because Mr. Hanschen's order relating to fishing and because Mr. Hanschen's mailing address is located in Minnesota.

The method 40 and label 70 or label 80 could be used in the follow scenario. Mr. Izzi, a customer located in St. Paul, Minn., orders a new digital camera from a web site called buy.com. When this order is placed, a person may enter information about Mr. Izzi and enter the information about the digital camera that he has ordered into a database. The database may then select a targeted advertisement for paper to print digital photographs on or new software for the digital camera that he may purchase for a discounted price (a coupon) from a mail order catalog affiliated with buy.com. After Mr. Izzi receives the order for the digital camera with the label 70, 80 attached to the box that the digital camera came in. Then, he may remove the second label 82 or cut along the dotted line 112 to remove the targeted advertisement 110 from the remaining portion of the label 70, 80. He may then redeem the coupon. The targeted advertisement was picked primarily because Mr. Izzi's order relating to digital cameras.

The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and, the equivalents of those structures.

What is claimed is:

1. A method of associating a targeted advertisement with a customer who ordered a product or service, comprising the steps of:
receiving an order from a customer for a product or service;
selecting an targeted advertisement based at least in part on one of the following:
information associated with the customer or
information associated with product or service ordered;
printing a label with the targeted advertisement;
applying the label to a package for the product or service; and
delivering the product to the customer with the targeted advertisement.

2. The method of claim 1, wherein the selecting step is in response to the receiving step.

3. The method of claim 1 further comprising the steps of:
notifying an advertiser that the advertisement has been sent to the customer.

4. The method of claim 1 further comprising the steps of:
charging an advertiser for the advertisement on the label.

5. The method of claim 1, wherein the label includes the customer's name and shipping address.

6. The method of claim 1, wherein the label includes a graphical representation of the ordered product or service.

7. The method of claim 1, wherein the label includes information to track the delivery of the product.

8. The method of claim 1, wherein the label is a length of tape cut from a roll of tape.

9. The method of claim 8, wherein the length of tape seals the package.

10. The method of claim 9, wherein the length of tape is adhered to two adjacent sides of a box.

11. The method of claim 8, wherein the tape is linerless tape.

12. The method of claim 1, wherein the printing step comprises printing the label in colored ink.

13. The method of claim 1, further comprising the steps of:
detaching the advertisement from the rest of the label and returning the
advertisement to the advertiser for a discount on an advertised product or service.

14. The method of claim of claim 1 further comprising the steps of:
returning, the advertisement for a discount on an advertised product or service.

15. A label made by the process of claim 1.

16. The method of claim 1, wherein the selecting step comprises selecting the advertisement from the computer database, and wherein after the receiving step, the method further comprises the step of:
recording the customer's order into a computer database; and.

17. The method of claim 1, wherein the advertisement is for a product or service similar to the product or service ordered by the customer.

18. The method of claim 1, wherein the advertisement is associated with a store located in the same geographical location as the customer.

19. The method of claim 1, wherein the printing step includes printing variable information on the label during one pass through a printer.

20. A label including a targeted advertisement, comprising:
a substrate including a first side and a second side opposite the first side;
a layer of adhesive on the second side of the substrate;
an advertisement printed on the first side of the substrate, wherein the advertisement is selected in response to one of the following:
information associated with the customer or
information associated with product or service ordered.

21. The label of claim 20, wherein label includes the customer's name and shipping address.

22. The label of claim 20, wherein the label includes a graphical representation of the ordered product or service.

23. The label of claim 20, wherein the label includes information to track the delivery of the product.

24. The label of claim 20, wherein the label is a length of tape cut from a roll of tape.

25. The label of claim 24 in combination with a package for the product, wherein the length of tape seals the package.

26. The label of claim 24 in combination with a box, wherein the length of tape is adhered to two adjacent sides of a box.

27. The label of claim 24, wherein the tape is linerless tape.

28. The label of claim 20, wherein the advertisement is printed in colored ink.

29. The label of claim 20, wherein the advertisement is detachable from the rest of the label.

30. The label of claim 20, wherein variable information is printed on the label during one pass through a printer.

31. A method of making a label for packaging for an ordered product, comprising the steps of:
receiving an order from a customer for a product;
printing a label with a graphical representation of the ordered product; and
applying the label to a package for the product.

32. The method of claim 31, wherein the printing step is in response to the receiving step.

33. The method of claim 31, wherein the label includes the customer's name and shipping address.

34. The method of claim 31, wherein the label includes information to track the delivery of the product.

35. The method of claim 31, wherein the label is a length of tape cut from a roll of tape.

36. The method of claim 35, wherein the length of tape seals the package.

37. The method of claim 35, wherein the length of tape is adhered to two adjacent sides of a box.

38. The method of claim 35, wherein the tape is linerless tape.

39. The method of claim 31, wherein the printing step comprises printing the label with colored inks.

40. The method of claim 31 further comprising the step of:
selecting an targeted advertisement based at least in part on one of the following:
information associated with the customer or
information associated with product or service ordered; and
wherein the printing step comprises printing the label with the targeted advertisement.

41. The method of claim 31 further comprising after the receiving step the steps of:
entering the customer's order into a computer database; and
selecting the graphical representation of the ordered product from the computer database.

42. The method of claim 31, wherein the printing setup includes printing variable information on the label during one pass through a printer.

43. A label made by the process of claim 31.

44. A label for an ordered product, comprising:
a substrate including a first side and a second side opposite the first side;
a layer of adhesive on the second side of the substrate;
a graphical representation of the ordered product printed on the first side of the substrate.

45. The label of claim 44, wherein label includes the customer's name and shipping address.

46. The label of claim 44, wherein the label includes information to track the delivery of the product.

47. The label of claim 44, wherein the label is a length of tape cut from a roll of tape.

48. The label of claim 47 in combination with a package for the product, wherein the length of tape seals the package.

49. The label of claim 47 in combination with a box, wherein the length of tape is adhered to two adjacent sides of a box.

50. The label of claim 47, wherein the tape is linerless tape.

51. The label of claim 44, wherein the label is printed with colored inks.

52. The label of claim 44 further comprising an advertisement printed on the first side of the substrate, wherein the advertisement is selected in response to one of the following:
information associated with the customer or
information associated with product ordered.

53. The label of claim 52, wherein the advertisement is detachable from the rest of the label.

54. The label of claim 44, wherein the label includes the total number of products ordered.

55. The label of claim 44 in combination with a package, wherein the graphical representation of the product corresponds to the product inside the package.

56. A label assembly comprising the label of claim 44 as a first label in combination with a second label, wherein the second label includes a first side, a second side opposite the first side, and a layer of adhesive on the second side of the substrate, wherein said layer of adhesive on the second side of the second label attaches the first label to the second label.

57. The label assembly of claim 56, wherein the first label includes a first label area, wherein the second label includes a second label area, and wherein the first area is greater than the second label area.

58. The label assembly of claim 57, wherein the second label is removable from the first label, and wherein the second label is a targeted advertisement.

59. The label assembly of claim 58, wherein variable information is printed on the label during one pass through a printer.

60. A label assembly, comprising:
a first label including a first major surface, a second major surface opposite the first major surface, and a layer of adhesive on the second major surface; and
a second label including a first major surface, a second major surface opposite the first major surface, and a layer of adhesive on the second major surface, wherein said first major surface of said first label is adhered to the second major surface of the second label by the adhesive on the second major surface of the second label;
wherein said first major surface of said first label has a first label area and said first major surface of second label has a second label area, and wherein said first label area is greater than said second label area.

61. The label assembly of claim 60, wherein the first label area is twice as large as the second label area.

62. The label assembly of claim 60, wherein the first label area is three times as large as the second label area.

63. The label assembly of claim 60, wherein the label assembly is printed in its assembled state.

64. The label assembly of claim 60, wherein the first label and second label are portions cut from a roll of tape.

65. The label assembly of claim 60, wherein the tape is linerless tape.

66. The label assembly of claim 60, wherein the second label is removable from the first label, and wherein the second label is a targeted advertisement.

67. The label assembly of claim 60 in combination with a package containing a product, wherein the label assembly further comprises a graphical representation of the product.

68. The label assembly of claim 65, wherein variable information is printed on the label assembly during one pass through a printer.

69. A method of printing a label assembly, comprising the steps of:
providing a label assembly, comprising:
a first label including a first major surface, a second major surface opposite the first major surface, and a layer of adhesive on the second major surface; and
a second label including a first major surface, a second major surface opposite the first major surface, and a layer of adhesive on the second major surface, wherein said first major surface of said first label is adhered to the second major surface of the second label by the adhesive on the second major surface of the second label; wherein said first major surface of said first label has a first label area and said first major surface of second label has a second label area, and wherein said first label area is greater than said second label area; and
printing information on the label assembly.
